(19) United States
(12) Patent Application Publication
(10) Pub. No.: US 2009/0108001 A1
(43) Pub. Date: Apr. 30, 2009

(54) CONTAINER

(75) Inventors: Richard Pryor, Leigh-on-Sea (GB); Richard Harbutt, Windsor (GB); James Pryor, Windsor (GB)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: DAIRY CREST LIMITED, Esher (GB)

(21) Appl. No.: 12/189,512

(22) Filed: Aug. 11, 2008

(30) Foreign Application Priority Data
Aug. 10, 2007 (GB) 0715660.7

(51) Int. Cl. B65D 25/14; B65D 45/16; B67D 5/00; B65D 5/74

(52) U.S. Cl. 220/495.03; 220/495.06; 220/324; 222/81; 222/566

(57) ABSTRACT

A container for dispensing liquid such as milk from a flexible bag or pouch has a lid with opposing clamps for clamping the top of the pouch and holding it taut, and a piercing member communicating with a spout which can be inserted through the lid to pierce the pouch.

### CROSS-REFERENCE TO RELATED APPLICATION

This application claims foreign priority to United Kingdom Patent Application No. 0715660.7 filed Aug. 10, 2007, which is herein incorporated by reference in its entirety.

### TECHNICAL FIELD

This invention relates to a container for use in dispensing liquids from a flexible bag or pouch.

### BACKGROUND

Liquid such as milk may be transported and sold to consumers in disposable, flexible bags. These bags have the advantage that they use substantially less plastics material than the alternative rigid plastic containers. However, it is difficult to dispense liquid directly from such flexible bags. It has therefore been desirable to decant the liquid by pouring it from the bag, for example into a re-usable rigid container or jug. This can be difficult to achieve without spillage. Alternatively, the bag may be placed in a jug with a corner of the bag cut off, and the jug may be used to assist in pouring from the bag. However this also causes problems with spillage from the bag, which is “loose” in the jug.

Various re-usable containers have been proposed for accepting a flexible bag, making an aperture in the bag and dispensing the liquid from the aperture. Some such arrangements include a cutter member for marking the aperture, and these arrangements usually push down on the bag within the container so as to hold it in place firmly enough to be cut. A problem with such an arrangement is that the contents of the bag are under some pressure, and tends to spurt out upon cutting.

### SUMMARY

According to embodiments of the present invention there is provided a container for dispensing liquid from a flexible bag, the container comprising a body having an opening for accepting the bag, and a lid for closing the opening, in which the container is configured to be engageable with the bag for holding an upper portion of the bag taut, and in which the container comprises a piercing member communicating with a spout for dispensing the liquid, the piercing member being arranged to pierce the bag at the taut upper portion.

According to embodiments of the present invention, by holding an upper portion of the bag in a taut condition, the contents are not pressurized, while the material of the bag is held firmly enough to be pierced.

The container is engageable with the bag at least two spaced positions so as to hold the bag taut between the two positions, according to embodiments of the present invention. For example, the body and the lid may each comprise cooperating engagement members for securing the lid to the body, and the container may be engageable with the bag by means of these cooperating engagement members, which may for example be provided at opposed positions adjacent the opening of the body portion, according to embodiments of the present invention.

Thus a bag may be placed in the body portion, the top of the bag may be stretched to overlap opposed sides of the opening, and the lid may be closed over the bag and fastened, according to embodiments of the present invention.

For example, the engagement members may be in the form of clamps arranged to clamp the bag therebetween, according to embodiments of the present invention. In some embodiments, they may be arranged for interengaging movement in mutually opposing directions. Thus, the action of clamping the bag may tend to increase the stretching of the bag between the clamps, according to embodiments of the present invention. In some embodiments, the engagement members or clamps may also comprise textured cooperating surfaces for increasing the frictional engagement of the bag. Thus when the piercing member engages the taut portion of the bag, the tendency of the bag to be pulled away from the clamps may be reduced, according to embodiments of the present invention.

According to embodiments of the present invention, the piercing member may be removably mounted on the container, and/or mounted in the lid. According to embodiments of the present invention, the piercing member is a tapered end of a tubular portion, the opposite end of which forms a spout. According to embodiments of the present invention, the tubular portion may be provided with sealing formations such as annular ridges to facilitate sealing of the aperture created in the bag with the tubular portion.

The spout may be mounted in a spout body fitting into a recess in the lid, according to embodiments of the present invention. In some embodiments, the spout may be provided with a movable cover member, such as a hinged cover for protecting the spout when not in use. The piercing member may be movably mounted in an aperture in the lid or lid recess, such that it may be pushed through the aperture when the container is closed with the bag inside, in order to pierce the taut portion of the bag, according to embodiments of the present invention.

A method according to an embodiment of the present invention includes dispensing liquid from a flexible bag comprising: placing the bag in a rigid container, securing an upper part of the bag in the container such that it is held taut, and piercing the upper part of the bag with a piercing member communicating with a spout.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a perspective view of a container according to one embodiment of the invention;

FIG. 2 is a perspective view of the container of FIG. 1 with the lid open, according to embodiments of the present invention;

FIG. 3 is a perspective view of the container of FIG. 1 with the lid partly closed, according to embodiments of the present invention;

FIG. 4 is a perspective view of the container of FIG. 1 with the spout body removed, according to embodiments of the present invention;

FIG. 5 is a perspective view of the container of FIG. 1 with the cover open, according to embodiments of the present invention;

FIG. 6 is a perspective view of the container of FIG. 1 with a bag being inserted therein, according to embodiments of the present invention;

FIG. 7 is a perspective view of the container of FIG. 1 with a bag being inserted therein, according to embodiments of the present invention;

FIG. 8 is a cross-sectional view of the container of FIG. 1, according to embodiments of the present invention; and,

FIGS. 8a, 8b, and 8c are enlarged views of corresponding circled portions A, B, and C of FIG. 8, according to embodiments of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

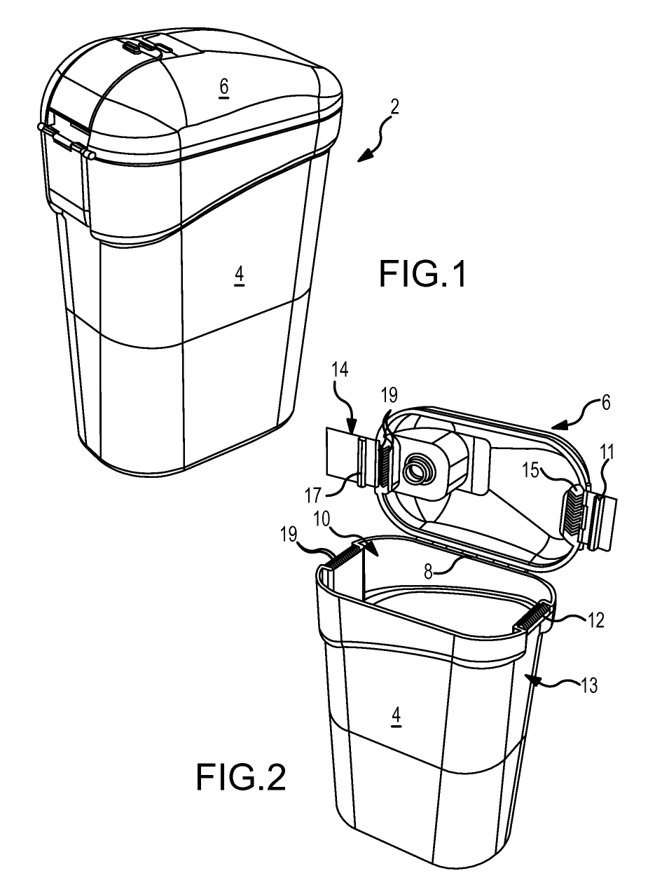

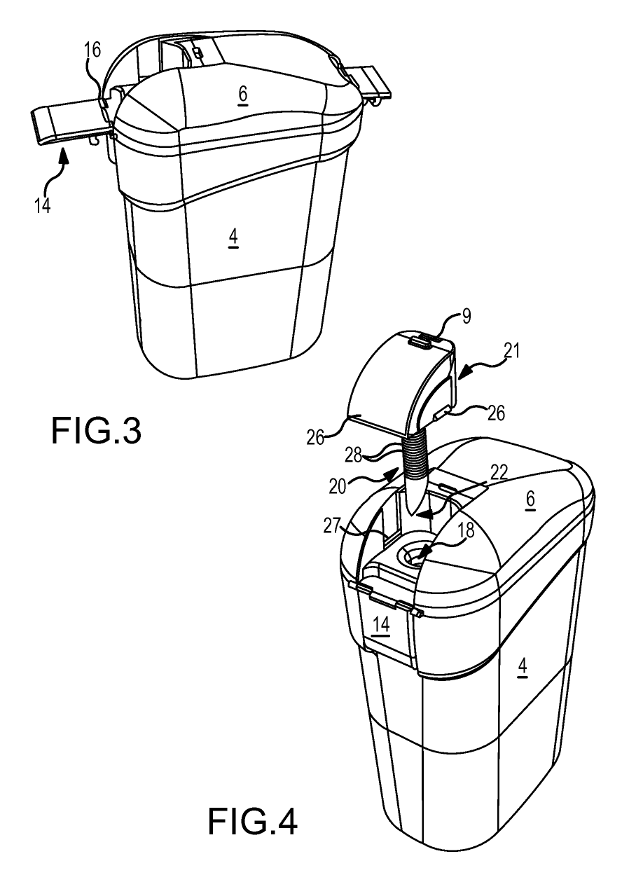

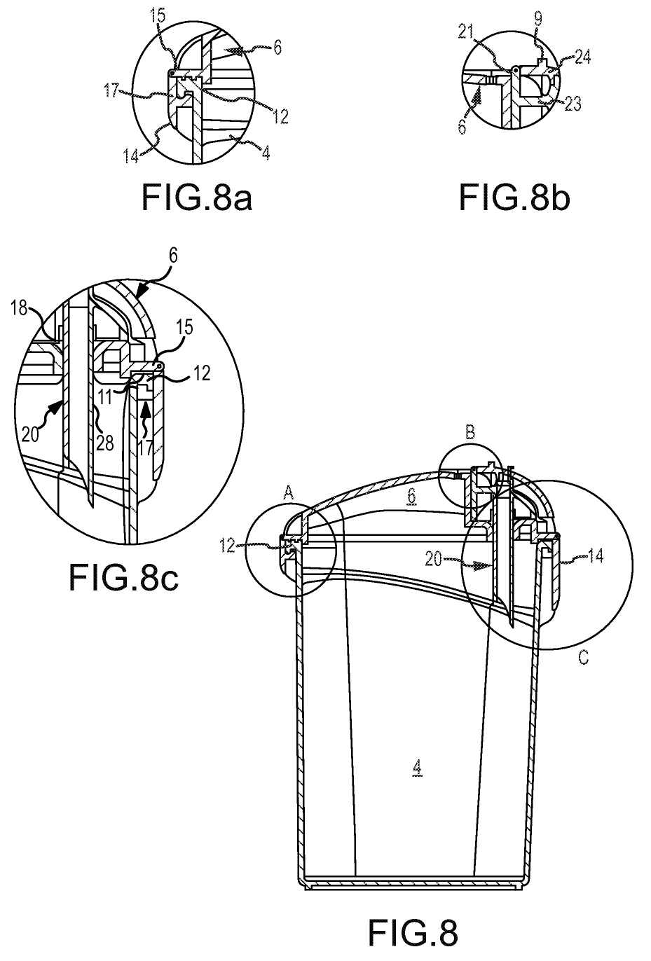

Referring to FIG. 1, the liquid dispensing container 2 comprises a body portion 4 and a lid portion 6, according to embodiments of the present invention. As can be seen from FIG. 2, the lid portion 6 is arranged to cover a generally rectangular opening 10 at the top of the body portion 4, according to embodiments of the present invention. In some embodiments, the lid portion 6 is joined to the body portion 4 by a hinge 8 along one side of the opening 10 in the container body portion 4. According to some embodiments, on the two opposed edges of the opening 10 adjacent the hinge 8, the lid portion 6 and the body portion 4 are both provided with cooperating engagement means. According to embodiments of the present invention, the cooperating engagement means is in the form of clamps comprising a pair of clamp plates 12 each extending outwardly of a recess or indented portions 13 in the body portion 4, and a pair of cooperating clamp levers 14 hingedly attached to the lid portion 6. Referring also to FIGS. 3 and 8, according to some embodiments, each clamp lever 14 is attached to the lid portion 6 by a clamp hinge 16, and has a flange 17 which is arranged to fit under the corresponding clamp plate 12 to engage the lid portion 6 with the body portion 4, according to embodiments of the present invention. The flange 17 and the underside of the clamp plate 12 may be shaped to produce a snap-fit, according to embodiments of the present invention. For example, the flange 17 and the underside of the clamp plate 12 may each have corresponding raised edges 11, according to embodiments of the present invention.

The underside of the lid portion 6 adjacent each clamp lever 14 has a clamp face 15 arranged to correspond to the upper surface of each clamp plate 12, according to embodiments of the present invention. The upper surface of each clamp plate 12 and the clamp faces 15 of the lid portion 6 are each provided with textured surfaces for gripping a portion of the bag clamped therebetween, according to embodiments of the present invention. According to some embodiments, the textured surfaces comprise inter-fitting chevron shaped ridges 19.

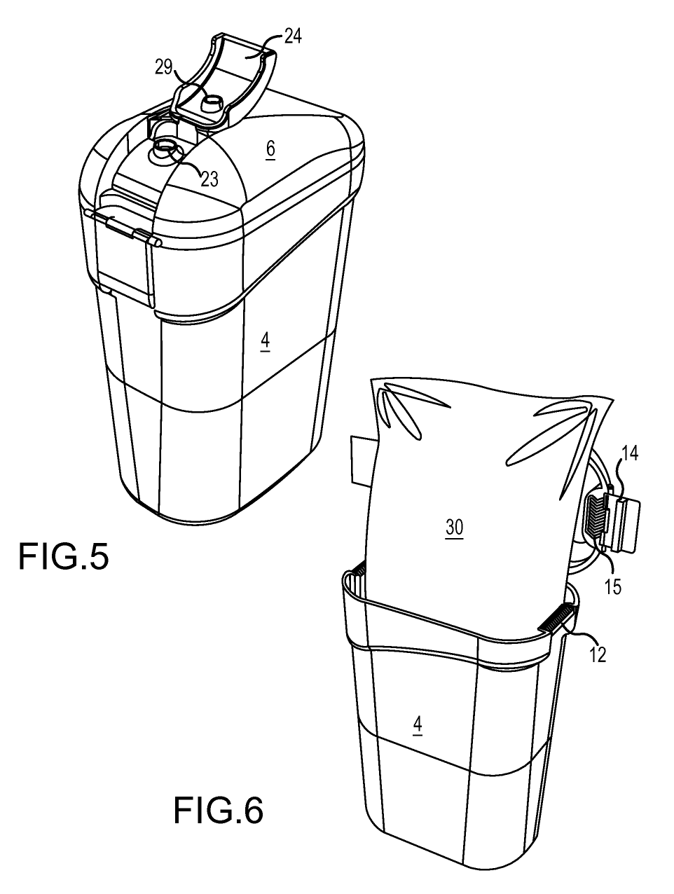

Referring to FIGS. 4 and 5, the lid portion 6 includes an aperture 18 which is sized to receive a tube 20, the first end 22 of which is tapered to provide a piercing member, according to embodiments of the present invention. The tube 20 is provided with a plurality of annular ridges 28 along its length, according to embodiments of the present invention. According to some embodiments of the present invention the aperture 18 is positioned between the two clamps 14 so as to be aligned in use with a portion of the bag held taught between the clamps 14. The second end of the tube 20 forms a spout 23 within a spout body 21 having a hinged cover 24, according to embodiments of the present invention. The cover 24 may include a grip 9 for use in opening the cover 24, and a spout seal 29 for fitting within the spout 23 when closed, according to embodiments of the present invention. The spout body 21 fits within a correspondingly shaped recess 25 in the lid portion 6, and is held therein by resilient legs 26 for engaging over projections 27 in the lid recess 25 in a snap-fitting manner, according to embodiments of the present invention.

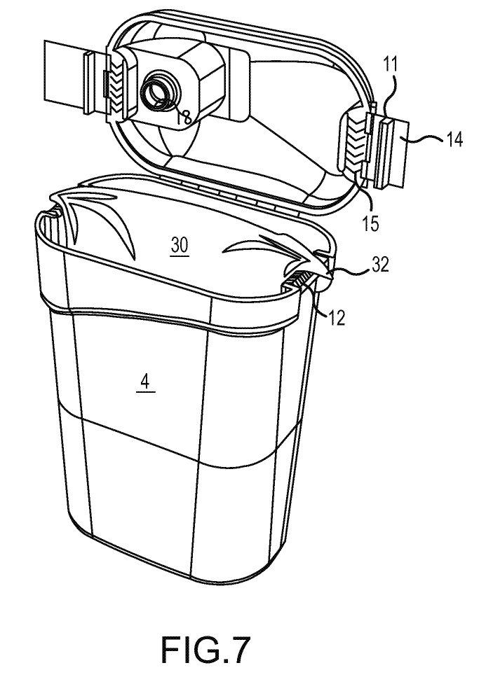

As shown in FIGS. 6 and 7, in use, a flexible bag or pouch 30 is placed into the body portion 4 of the container 2 via the opening 10, according to embodiments of the present invention. The user grips the upper corners or ears 32 of the bag and stretches them over the clamp plates 12, according to embodiments of the present invention. In this position, the lid portion 6 is lowered until the clamp faces 15 of the lid portion 6 abut the upper surfaces of the clamp plates 12 of the body portion 4, according to embodiments of the present invention. The two clamp levers 14 are then pushed down and inwardly such that the flanges 17 engage under the clamp plates 12, with the raised edges 11 passing over each other, securing the lid portion 6 to the body portion 4, according to embodiments of the present invention. This action also serves to pull the upper corners or ears 32 of the bag 30 in opposing directions ensuring that the upper portion of the bag 30 is taut, according to embodiments of the present invention.

According to embodiments of the present invention, the two opposed upper corners or ears 32 of the bag 30 are thus compressed between the textured surfaces of the body portion 4 and the lid portion 6, and frictionally engaged so as to retain the top of the bag 30 in the taut condition, according to embodiments of the present invention. In some embodiments, the tube 20 is then pushed through the aperture 18, such that the piercing member 22 pierces the taut upper portion of the bag 30. In some embodiments, the textured surfaces oppose the tendency for the bag 30 to be pulled away from the clamps when the piercing member 22 is pushed down. According to some embodiments, the aperture thus formed in the bag 30 stretches around to tube 20, and seals against one of the ridges 28. The contents of the bag 30 may then be dispensed via the spout 23, according to embodiments of the present invention.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A container for dispensing liquid from a flexible bag, the container comprising a body having an opening for accepting the bag, a lid for closing the opening, and cooperating engagement members for securing the lid on the body, the engagement members being configured to be engageable with the bag at least two spaced positions so as to hold an upper portion of the bag taut between the two positions, and in which the container comprises a piercing member communicating with a spout for dispensing the liquid, the piercing member being arranged to pierce the bag at the taut upper portion.

2. A container as claimed in claim 1 in which the cooperating engagement members are provided at opposed positions adjacent the opening of the body portion.

3. A container as claimed in claim 1, in which the engagement members comprise clamps arranged to clamp the bag therebetween.

4. A container as claimed in claim 3, in which the clamps are arranged for interengaging movement in mutually opposing directions, such that, in use, the action of clamping the bag tends to increase the stretching of the bag between the clamps.

5. A container as claimed in claim 1, in which the engagement members comprise textured cooperating surfaces, for frictional engagement with the bag.

6. A container as claimed in claim 1, in which the piercing member is removably mounted on the container.

7. A container as claimed in claim 1, in which the piercing member is mounted in the lid.

8. A container as claimed in claim 1, in which the piercing member is a tapered end of a tubular portion, the opposite end of which forms the spout.

9. A container as claimed in claim 8, in which the tubular portion is provided with sealing formations to facilitate sealing of an aperture created in the bag with the tubular portion.

10. A container as claimed in claim 9, in which the sealing formations comprises annular ridges.

11. A container as claimed in claim 1, in which the spout is mounted in a spout body fitting into a recess in the lid.

12. A container as claimed in claim 1, in which the spout is provided with a movable cover member.

13. A container as claimed in claim 1, in which the piercing member is movably mounted in an aperture in the lid or lid recess, such that the piercing member may be pushed through the aperture in the lid or lid recess when the container is closed with the bag inside in order to pierce the taut portion of the bag.
